(19) United States
(12) Patent Application Publication
(10) Pub. No.: US 2007/0124936 A1
(43) Pub. Date: Jun. 7, 2007

(54) Rotary electric shaver

(75) Inventor: Masaki Okabe, Matsumoto (JP)

Correspondence Address: KODA & ANDROLIA, 2029 CENTURY PARK EAST, SUITE 1140, LOS ANGELES, CA, 90067, US

(73) Assignee: IZUMI PRODUCTS COMPANY

(21) Appl. No.: 11/634,578

(22) Filed: Dec. 6, 2006

(30) Foreign Application Priority Data
Dec. 7, 2005 (JP) 2005-353515

(51) Int. Cl. B26B 19/14

(52) U.S. Cl. 30/43.6

(57) ABSTRACT

A rotary electric shaver including a plurality of substantially disc-shaped outer cutters, which are provided in the upper part of a shaver main body housing therein a motor, and inner cutters, which engage the outer cutters from below and are rotationally driven by the motor so as to cut hair entering into the hair introduction openings formed in the outer cutters; and in addition, substantially cylindrical cutter frames 18 for respectively holding the outer cutters in a depressible manner are provided so that cutter frames 18 can pivot in the upper surface of the shaver main body.

### BACKGROUND OF THE INVENTION

1. Field of the Invention

The present invention relates to a rotary electric shaver in which an outer cutter(s) is provided in the upper part of a shaver main body that houses a motor, and an inner cutter(s) rotated while being elastically contacting the inner surface(s) of the outer cutter(s) cuts hair entered into the hair introduction openings formed in the outer cutter(s).

2. Description of the Related Art

In this type of electric shaver, the outer cutters are generally depressible in order to enhance the tightness of contact between the outer cutters and the skin during shaving. In other words, outer cutter mounting holes are formed in an outer cutter frame fitted to the shaver main body, and outer cutters are provided in the outer cutter mounting holes from below so that the outer cutters are pushed upward elastically.

In this structure, compressed coil springs are mounted on the rotary shafts that are for rotationally driving the inner cutters, so that an upwardly-directed returning tendency is imparted to the rotary shafts by the compressed coil springs; and the inner cutters are made to elastically contact the outer cutters by the upward restorative force on the rotary shafts, so that a restorative force is imparted to the outer cutters. As a result, the outer cutters can be pressed downward, and, at the same time, are pivotable within the range of the gaps between the outer cutter mounting holes in the outer cutter frame and the outer circumferences of the outer cutters.

In such shavers as described above in which the outer cutters are made capable of pivoting relative to the outer cutter frame, when the angular range of outer cutter pivot motion is small, and particularly when the curvature of the irregularities in the skin is small, then the tightness of contact between the outer cutters and the skin tends to be insufficient. When the skin cannot make tight contact with the entire surfaces of the outer cutters, moreover, outer cutter utilization efficiency deteriorates, and the feel of shaving is also degraded.

One conceivable way of resolving the above problems would be to increase the allowable angle of pivot motion of the outer cutters with respect to the outer cutter frame. In that case, however, the circumferential edges of the outer cutters would contact the skin at an acute angle, and the contact pressure of the skin against the circumferential edges of the outer cutters would increase. As a result, the skin would be pressed into the hair introduction openings of the outer cutter(s), resulting in such problems as excessively close shaves or a burning sensation remaining after shaving.

PCT International Publication No. H9-503424 (1997) proposes a shaver in which skin supporting rims are provided between the outer cutters and the outer cutter frame, and the skin supporting rims are designed so as to pivot relative to the outer cutter frame. More specifically, by enclosing the outer circumferences of the outer cutters with the skin supporting rims, and causing such skin supporting rims to pivot together with the outer cutters, the skin is prevented by the skin supporting rims from deeply pressing into the outer circumferential edges of the outer cutters when the outer cutters are tilted.

In the above structure, three outer cutters are respectively and separately enclosed by skin supporting rims, and these three skin supporting rims are provided in a single outer cutter frame that is secured to the shaver main body. More specifically, in each of the skin supporting rims, a pair of projections that protrude outwardly are provided at positions which are symmetrical relative to straight lines in the radial direction that pass through the center of the upper surface of the shaver main body, and such projections are engaged in the outer cutter frame. Accordingly, the skin supporting rims pivot about straight lines passing through the pairs of projections toward the center side and toward the outer side of the upper surface of the shaver main body. Three skin supporting rims are mutually linked by hinges so as to move together.

In this shaver in which the skin supporting rims are made capable of pivoting inside the outer cutter frame, the three skin supporting rims are moved together on hinges; as a result, when one skin supporting rim tilts toward the center of the shaver main body, the other two skin supporting rims will also tilt toward the center of the shaver main body. As a result, the problem is that not all of the outer cutters faithfully follow the irregularities in the skin, so that the feel of shaving tends to be unpleasant. Furthermore, the projections provided on the outer circumferences of the skin supporting rims are engaged with the inner circumferences of the outer cutter frame (the inner circumferences of the portions enclosing the skin supporting rims); as a result, the outer diameters of the outer cutter frame needs to be larger. Accordingly, the size of the shaver head attached to the upper part of the shaver main body tends to be larger, and, particularly in cases where a plurality of outer cutters are provided, the shaver's overall size becomes larger, which is a problem.

### BRIEF SUMMARY OF THE INVENTION

Accordingly, it is an object of the present invention, devised in view of the above-described circumstances, to provide a rotary electric shaver that has an increased angular range for a pivot motion of outer cutters, thus enhancing the tightness of contact of the outer cutters against the skin, and improving outer cutter utilization efficiency.

It is another object of the present invention to provide a rotary electric shaver in which the size of the shaver head is prevented from becoming larger, thus facilitating making the electric shaver more compact.

The above objects are accomplished by a unique structure of the present invention for a rotary electric shaver that includes a plurality of substantially disc-shaped outer cutters, which are provided in the upper part of a shaver main body that houses a motor therein, and inner cutters, which respectively engage the outer cutters from below and are rotationally driven by the motor so as to cut hair entering into the hair introduction openings formed in the outer cutters; and in the present invention, substantially cylindrical cutter frames for holding the outer cutters therein so that the outer cutters are depressible are provided so that cutter frames are pivoted in the upper surface of the shaver main body, separately for each outer cutter.

As seen from the above, in the shaver of the present invention, the outer cutters are provided so that they are depressible (or sinkable into) respectively with respect to the cutter frames, and provision is made so that, by holding the cutter frames in the shaver main body so that the cutter frames are pivotable directly, each of the cutter frames is able to make independent action, thus providing sufficient angular range of pivot motion for the outer cutters with respect to the shaver main body. As a result, the tightness of contact of the outer cutters against the skin increases, outer cutter utilization efficiency is improved, and hair cutting quality is improved. In addition, since the cutter frames are directly provided in the shaver main body, the shaver head can be made smaller, and this makes it possible to design the overall size of electric shavers smaller.

In the present invention, the cutter frames can be respectively provided in supporting portions that are formed so as to be raised on the upper surface of the shaver main body; and with this structure, the portions that hold the cutter frames are extremely small, so that the shaver head can be compact.

It is preferable in the present invention that the cutter frames be made so that they can respectively pivot about straight lines that pass through the centers of the outer cutters and intersect at right angles straight lines passing through the center of the shaver main body and the centers of the outer cutters held in the cutter frames, when viewed from above (when viewed in the direction of the axis of rotation of the inner cutters). With this structure, the outer cutters are able to pivot largely to the outer circumferential side and to the center side of the upper surface of the shaver main body. As a result, the outer cutters can snugly follow the irregularities in the skin during the shaving.

When the shaver has three outer cutters, it is preferable that the centers of the outer cutters be positioned at positions of the apexes of an equilateral triangle when viewed from above on the upper surface of the shaver main body.

Furthermore, to the outer cutters and cutter frames, a restorative force in a pushing-up (outward) direction can be elastically imparted by the inner cutters. More specifically, rotary shafts for rotationally driving the inner cutters are provided so as to elastically push the inner cutters upward, so that an upwardly-directed restorative force is thus imparted by the rotary shafts, through the inner cutters, to the outer cutters and to the cutter frames.

Furthermore, a cutter frame return spring for restoring the corresponding each one of the cutter frames to an upright position can be provided between each cutter frame and the upper surface of the shaver main body; and further, an outer cutter return spring for urging the corresponding each one of the outer cutters upward can be provided in each cutter frame. By way, in this manner, of urging the cutter frames and outer cutters upward independently by springs that are provided separately from the inner cutter rotating shafts that give the restorative force to the outer cutters, it is possible to set the respective restorative forces independently, and the degree of freedom of setting preferable restorative forces increases.

### BRIEF DESCRIPTION OF THE SEVERAL VIEWS OF THE DRAWINGS

FIG. 1 is an exploded perspective view of the rotary electric shaver according to one embodiment of the present invention, a part thereof being omitted;

FIG. 2 is a top view of the shaver head of the shaver of FIG. 1;

FIG. 3 is a top view of the shaver head with the outer cutters removed;

FIG. 4 is a cross sectional view taken along the lines 4-4 in FIG. 2;

FIG. 5 is a cross sectional view taken along the lines 5-5 in FIG. 2;

FIG. 6 is an enlarged cross sectional view of one cutter unit provided in the shaver head, being taken along the axis of pivot motion of the cutter frame;

FIG. 7 is a partial top view of the cutter frame return spring;

FIG. 8 shows the cross section of the cutter frame return spring taken along the lines 8-8 in FIG. 7; and

FIGS. 9(A) through 9(C) are diagrams showing the manners of motions of the cutter frames during the use of the shaver, viewing in the direction of the lines 5-5 in FIG. 2.

### DETAILED DESCRIPTION OF THE INVENTION

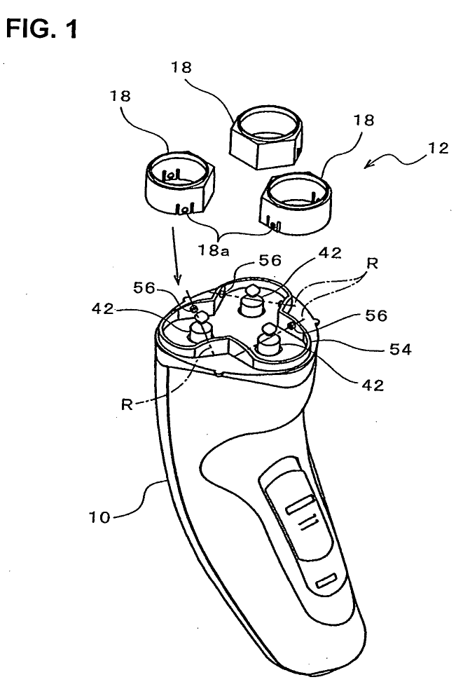

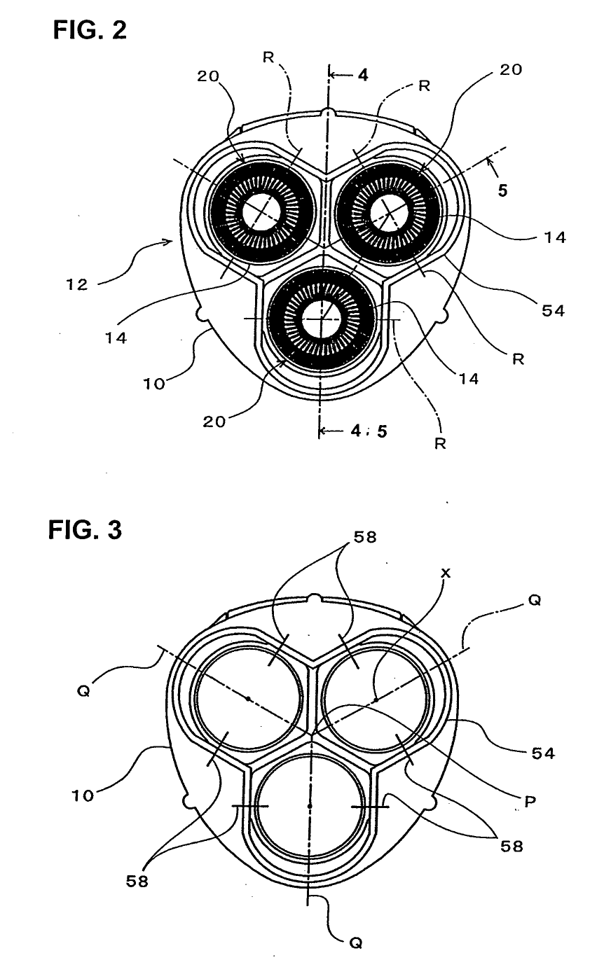

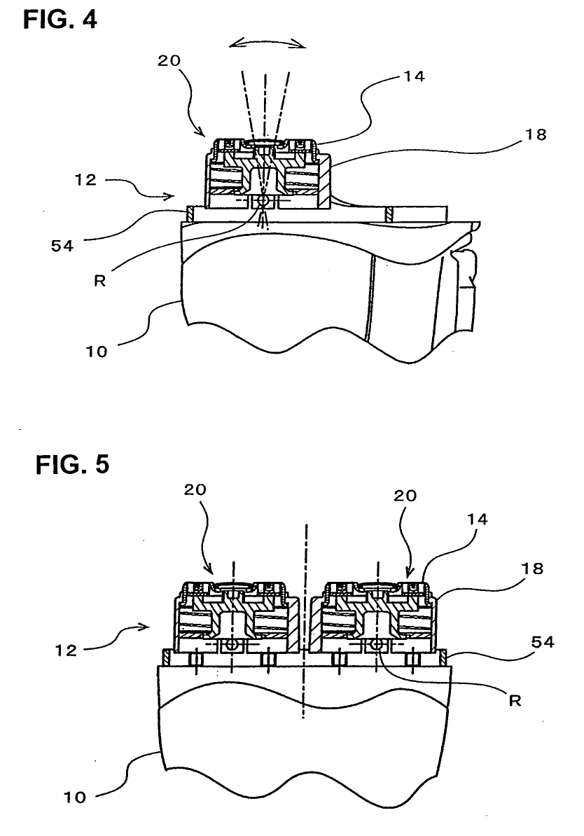

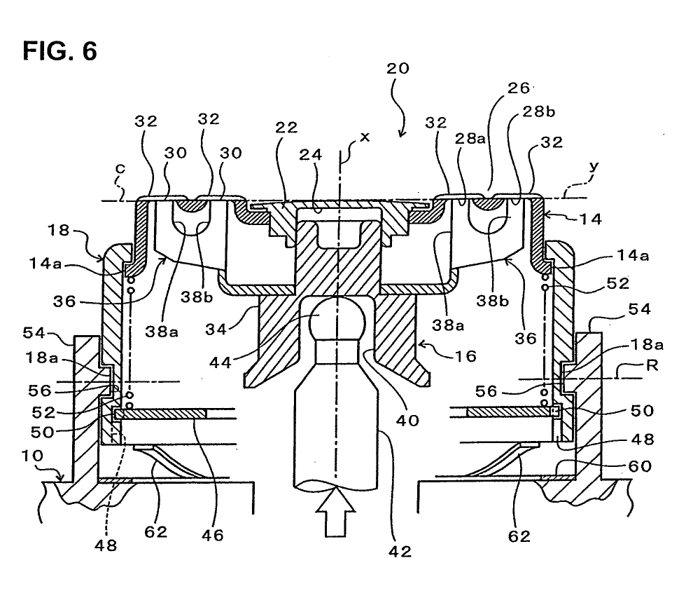

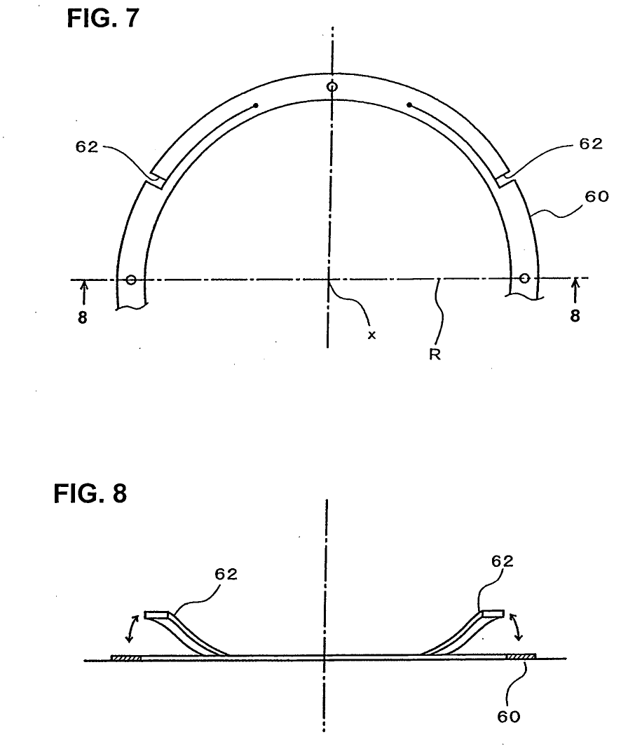

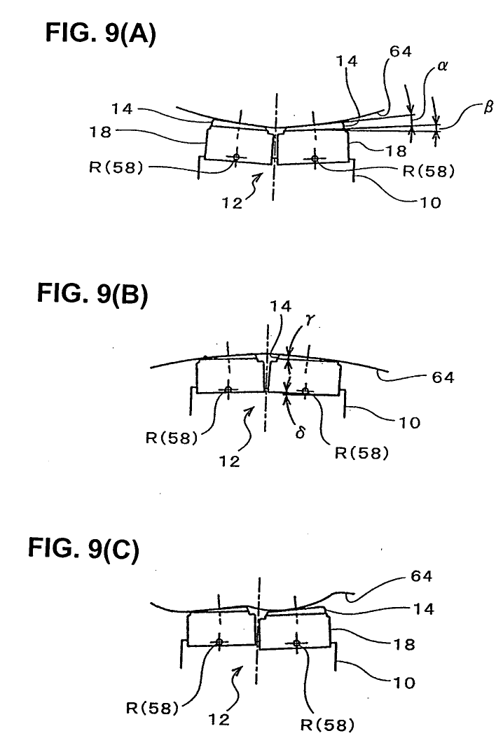

The rotary electric shaver of the present invention will be described in detail below with reference to the accompanying drawings in which FIG. 1 is an exploded perspective view of one embodiment of the shaver with the cutter frames separated from the shaver main body, FIG. 2 shows the top part of the shaver head, FIG. 3 shows the top part of the shaver head with the outer cutters removed, FIG. 4 shows in cross section the outer and inner cutters inside a cutter frame, FIG. 5 shows in cross section the outer and inner cutters inside cutter frames next to each other, FIG. 6 shows one cutter unit, FIG. 7 shows half of a cutter frame return spring, and FIG. 8 shows the cutter frame return spring taken seen from the side. In addition, FIGS. 9(A) through 9(C) illustrate how the outer cutters and cutter frames make their motions.

In FIG. 1, the reference numeral 10 designates a shaver main body, and 12 a shaver head provided on the upper part of the shaver main body 10. In this shaver head 12 are provided three cutter units 20 each comprising, among others, (as seen from FIG. 6) an outer cutter 14, an inner cutter 16, and a cutter frame 18. As seen from FIG. 2, the centers of the outer cutters 14 of the three cutter units 20 are positioned at apexes of an equilateral triangle when viewed from above.

Each one of the outer cutters 14 is made of metal sheet into substantially a bowl shape that is upwardly convex (see FIG. 4 to 6). The upper face of the outer cutter 14 is circular (disk-shaped), and a round opening is formed in the center of the circular face, and, as seen from FIG. 6, a cap 22 is secured to this round opening from above. The cap 22 has an engagement hole 24 in its lower surface; and the tip (top) end of an inner cutter 16, described below, is engaged with this engagement hole 24 of the cap 22, so that axial wobbling in the inner cutter 16 is prevented.

In the circular top face of each outer cutter 14, a ring-shaped groove 26 when viewed from above is formed so as to be centered on the center axis x (see FIG. 6) that is the center of rotation of the inner cutter 16, and a pair of ring-shaped inside and outside thin-layer portions are formed along both sides of the ring-shaped groove 26. The upper surfaces of these thin-layer portions of the outer cutter make skin-contacting surfaces, and the lower surfaces make inner cutter running grooves 28a and 28b.

Each outer cutter 14 is formed with a multiplicity of long slit-form hair introduction openings 30 (FIG. 2) so that they cross the thin-layer portions from substantially the center thereof in radial directions. Ribs 32 are formed between the hair introduction openings 30 adjacent in the thin-layer portions, and the bottom surfaces of the ribs 32 make cutting edges that work with the corresponding inner cutter 16 to cut the hair entering the hair introduction openings 30.

The upper surface of the outer cutter 14 (or the upper surfaces of the ribs 32) is positioned on a plane that intersects at right angles the center axis x (i.e. a plane to which the center axis x is perpendicular) as seen from FIG. 6. In other words, the upper surfaces of the ribs 32 are formed flat.

The lower surfaces of the thin-layer portions of each outer cutter 14 (that is, the bottom surfaces of the ribs 32) make, respectively, the inner cutter running grooves (ring-shaped tracks) 28a and 28b. The surfaces (bottom surfaces) of the inner cutter running grooves 28a and 28b lie on a flat plane y that intersects at right angles the center axis x. The flat plane y coincides with the bottom surfaces of the ribs 32. These lower surfaces are polished by grindstones so that cutting edges are formed on the lower edges of the ribs 32.

Each of the inner cutters 16 is, as seen from FIG. 6, comprised of a hub 34, which is made of resin and opens downward, and a plurality of cutter bodies 36, which are secured to the hub 34 at equal intervals in the circumferential direction about that hub 34. The cutter bodies 36 can be linked to form into a ring. The upper portion of each one of the cutter bodies 36 is bifurcated into a two-pronged shape to form two cutter blades 38a and 38b, so that the cutter blades 38a and 38b respectively slide against the inner cutter running grooves (tracks) 28a and 28b of the outer cutter 14 from below. The upper edges of the cutter blades 38a and 38b of the inner cutter 16 form cutting edges, that is, blade tips, which are polished horizontally along the flat plane y.

In FIG. 6, an engagement recess 40 which is square when viewed from below and opens downward is formed in the hub 34, and a rotary shaft 42 protruding from the shaver main body 10 engages this engagement recess 40 of the inner cutter 16. The rotary shaft 42 has at its upper end a square spherical engagement head 44 that engages from below the engagement recess 40 of the hub 34 of the inner cutter 16. The rotary shaft 42 is rotationally driven by a motor (not shown) housed in the interior of the shaver main body 10 and rotates the inner cutter 16.

The rotary shaft 42 has a return tendency in the upwardly protruding direction and presses the inner cutter 16 upward (or in the direction opposite from the shaver main body 10). As a result, the cutter blades 38a and 38b of the inner cutter 16 elastically press against the inner cutter running grooves 28a and 28b of the outer cutter 14 from below; and thus, the cutter unit 20 that is comprised of the outer cutter 14 and the inner cutter 16 is capable of elastically sinking (or depressible) downwardly with respect to the cutter frame 18. In other words, the upwardly directed return force of the rotary shaft 42 is a part of the outer cutter pushing-up spring load that pushes the outer cutter 14 upward.

Next, the cutter frames 18 will be described.

Each cutter frame 18 is, as seen from FIG. 1, in substantially a cylindrical shape. Into the inner circumferential edge at the upper end thereof, as seen from FIG. 6, a flange 14a which is formed on the outer circumferential lower edge of the outer cutter 14 is engaged from below, so that the cutter frame 18 holds the outer cutter 14 therein in such a manner that the outer cutter 14 is depressible (sinkable) downwardly.

To the inner circumferential surface of the lower part of that cutter frame 18, an outer cutter pressure plate 46 is attached from below in a manner that the outer cutter pressure plate 46 can be engaged and disengaged. More specifically, a plurality of longitudinal grooves 48 that open downwardly and the upper portions thereof are bent horizontal are formed in the inner circumferential surface of the cutter frame 18, and the outer circumference of the outer cutter pressure plate 46 is formed with projections 50 which are engageable with the longitudinal grooves 48; and when these projections 50 are inserted from below into the longitudinal grooves 48 and the pressure plate 46 is slightly turned, the projections 50 of the pressure plate 46 are engaged in the horizontally bent portions in the upper parts of the longitudinal grooves 48, and, as a result, the pressure plate 46 is thus detachably mounted to the inner circumferential surface of the cutter frame 18.

Between the upper surface of this outer cutter pressure plate 46 and the flange 14a which is at the lower edge of the outer cutter 14, a coil spring (outer cutter push-up spring) 52 is provided in a compressed manner, so that an upwardly-directed restorative force is imparted to the outer cutter 14 by this spring 52.

On the upper surface of the shaver main body 10, as seen from FIGS. 1 to 3, a substantially three-leaf shaped upright wall 54 is formed so as to be raised to spacedly enclose the three rotary shafts 42 in a circular arc shape; and three cutter frames 18 are respectively provided in this upright wall 54 so that they can pivot by convexities 56 formed on the inner circumferential surface of the upright wall 54. More specifically, three pairs of projections (convexities) 56 and 56 are respectively formed on the inner surfaces of the upright wall 54 at substantially symmetrical positions respectively with reference to the rotary shafts 42, and concavities 18a are formed on the outer surfaces of each one of the three cutter frames 18 at substantially symmetrical positions, so that the concavities 18a of the cutter frame 18 are engaged with each the projections 56 and 56. With these concavities 18a and convexities 56, pairs of supporting points 58 are, as seen from FIG. 3, formed for each one of the three cutter frames 18, so that each cutter frame 18 is pivotable about the supporting points 58.

The supporting points 58 are, as shown in FIG. 2, positioned on straight lines R. More specifically, each straight line R intersects at right angles a straight line Q (see FIG. 3) that passes through both the center P of the shaver main body 10, when viewed from above, and the center x (identical with the rotational center axis x in FIG. 6) of the outer cutter 14 held by each one of the cutter frames 18, the straight line R further passing through the center x. As a result, each one of three straight lines R constitutes the axis of pivot motion of each one of the three cutter frames 18.

As seen from FIG. 6, between the lower edge of each cutter frame 18 and the upper surface of the shaver main body 10, a ring-shaped flat spring 60 that constitutes a cutter frame push-up spring is provided.

The flat spring 60, as seen from FIGS. 7 and 8, has substantially the same outer diameter as the cylindrical cutter frame 18, and at four points (FIG. 7 shows only two of them) on the outer circumferential side of the flat spring 60, cut and raised portions 62 are formed so as to be elongated along the circumferential direction. The cut and raised portions 62 at four places of the flat spring 60 are formed such that the free ends thereof are in contact with the lower edge of each cutter frame 18, so that by the elasticity of the cut and raised portions 62, the cutter frame 18 is urged upward. The four cut and raised portions 62 are formed symmetrically relative to the axis of pivot R of the cutter frame 18 and urges the cutter frame 18 so that the cutter frame 18 can return to its vertical upright position after making pivot motions.

With the structure described above, the respective cutter units 20 are capable of making pivot motions independently, respectively, within a prescribed angular range, about the axis of pivot R as a pivot center as shown by curved arrow in FIG. 4. Accordingly, when an exterior force is applied to an outer cutter 14 in a direction crossing the axis of pivot R, the cutter unit 20 pivots accordingly in the same direction, and, as a result, the cutter frame 18 compresses two of the cut and raised portions 62 on the pivot side. When the exterior force is removed and no longer is applied to the outer cutter 14, then the cutter unit 20 returns to its original upright position by the restorative force of those two cut and raised portions 62 of the flat spring 60 that have been compressed.

When an exterior force in a direction parallel to the turning axis x (downward oriented exterior force) is applied to an outer cutter 14, then such an outer cutter 14 is depressed (or sinks in) against the spring force of the coil spring 52 and the upward-oriented return tendency force of the rotary shaft 42. When the external force ceases, the outer cutter 14 returns to its original position (position illustrated in FIGS. 4, 5, and 6).

Next, the operation of the cutter frames 18 will be described below with reference to FIGS. 9(A) through 9(C).

When the skin 64 is gently convex, and the shaver head 12 is pressed against such a skin 64, as shown in FIG. 9(A), the outer cutters 14 tilt by an angle α toward the center of the shaver head 12 (or tilt inwardly) relative to the cutter frames 18, and the cutter frames 18 pivot by an angle β relative to the upper surface of the shaver main body 10. As a result, the outer cutters 14 are able to tilt by an angle of α+β degrees toward the outside relative to the shaver main body 10. Thus, the outer cutters 14 have an expanded movable range and are able to make a tight and snug contact with the skin 64, thus providing an increased outer cutter utilization efficiency.

When the skin 64 is gently concave, and the shaver head 12 is pressed against such a skin 64, then, as shown in FIG. 9(B), the outer cutters 14 tilt by an angle γ toward the outside of the shaver head 12 relative to the cutter frames 18, and the cutter frames 18 pivot by an angle δ in the same outer direction relative to the upper surface of the shaver main body 10. As a consequence, the outer cutters 14 can tilt by an angle of γ+δ degrees toward the outside relative to the shaver main body 10.

For the skin 64 that has irregular (non-smooth) surface, as shown in FIG. 9(C), the outer cutters 14 tilt independently in appropriate directions so as to correspond to the irregularities of the skin 64, keeping enhanced tightness of the contact with the skin 64.

1. A rotary electric shaver comprising a plurality of substantially disc-shaped outer cutters provided in an upper part of a shaver main body housing therein a motor, and inner cutters that engage the outer cutters from below and are rotationally driven by said motor so as to cut hair entering into hair introduction openings formed in said outer cutters, wherein
substantially cylindrical cutter frames for respectively holding said outer cutters therein so that said outer cutters are depressible are pivotally provided on an upper surface of said shaver main body.

2. The rotary electric shaver according to claim 1, wherein said cutter frames are provided in supporting portions raised on said upper surface of said shaver main body.

3. The rotary electric shaver according to claim 1, wherein said cutter frames are respectively pivotable about pivot centers respectively comprising straight lines that pass through centers of said outer cutters and intersect at right angles straight lines passing through both a center of said shaver main body and the centers of said outer cutters held in said cutter frames.

4. The rotary electric shaver according to claim 3, wherein three outer cutters and three cutter frames for holding said outer cutters are provided on said upper surface of said shaver main body at positions constituting apexes of an equilateral triangle.

5. The rotary electric shaver according to claim 1, wherein
rotary shafts for respectively rotating said inner cutters while elastically pushing up said inner cutters are provided to protrude from said upper surface of said shaver main body, and
an upwardly-directed restorative force is imparted to said outer cutters, through said inner cutters, by said rotary shafts.

6. The rotary electric shaver according to claim 1, further comprising a cutter frame return spring for returning each one of said cutter frames to an upright position, said spring being provided between each one of said cutter frames and said upper surface of said shaver main body.

7. The rotary electric shaver according to claim 1, further comprising an outer cutter push-up spring provided in each one of said outer cutters for urging each one of said outer cutters upward.
